(19) United States
(12) Patent Application Publication
(10) Pub. No.: US 2025/0185128 A1
(43) Pub. Date: Jun. 5, 2025

(54) FURNACE POWER SUPPLY APPARATUS, SYSTEM FOR THE POWER SUPPLY OF AN ELECTRIC ARC FURNACE OR A SUBMERGED ARC-RESISTANCE FURNACE, ELECTRIC ARC FURNACE OR SUBMERGED ARC-RESISTANCE FURNACE AND OPERATING METHOD

(71) Applicant: SMS Group S.P.A., Tarcento (IT)

(72) Inventors: Luca Neri, Udine (IT); Guido Michelon, Gorizia (IT)

(21) Appl. No.: 18/843,968

(22) PCT Filed: Mar. 4, 2023
(86) PCT No.: PCT/EP2023/055521

§ 371 Date: Sep. 4, 2024

(30) Foreign Application Priority Data
Mar. 4, 2022 (DE) 10 2022 105 169.2

(51) Int. Cl. H05B 7/148; F27B 3/08; F27B 3/28; H02M 1/14; H02M 7/04; H05B 7/18

(52) U.S. Cl. CPC H05B 7/148; F27B 3/085; F27B 3/28; H02M 1/14; H02M 7/04; H05B 7/18

(57) ABSTRACT

The present invention discloses a furnace power supply apparatus for the supply of an electric arc furnace or a submerged arc-resistance furnace with electric energy, —wherein the furnace power supply apparatus is connectable to a three-phase power network, —wherein the furnace power supply apparatus is connectable to at least one electrode of the electric arc furnace or the submerged arc-resistance furnace, —wherein the furnace power supply apparatus comprises: —a three-phase transformer with a primary circuit per phase and a secondary circuit per phase, in particular exactly one secondary circuit per phase, —a rectifier circuit, and—preferably a smoothing circuit zoo connected to the rectifier circuit, —and wherein the three-phase transformer is a phase-shifting transformer.

The present invention relates to a furnace power supply apparatus, a system for the power supply of an electric arc furnace or a submerged arc-resistance furnace, an electric arc furnace or a submerged arc-resistance furnace and an operating method.

Metals, especially steel, are regularly melted and heated by an electric arc in melting units. These electrically operated melting units, in particular an electric arc furnace or a submerged arc-resistance furnaces, are operated with direct current, alternating current (AC) or three-phase AC current. Usually, at least one electrode is used for this purpose, which projects through the furnace lid into the furnace vessel, while the other electrodes are provided corresponding to the first electrode or are arranged in the bottom of the melting vessel.

Electric arc furnaces or a submerged arc-resistance furnaces represent a highly nonlinear load, which means that the operation of an electric arc furnace or a submerged arc-resistance furnace can lead to undesirable electrical network distortions, in particular flicker, higher harmonic currents, and the like, on the electrical supply network.

The invention is based on the task of providing the state of the art with an improvement or an alternative.

According to a first aspect of the invention, the task is solved by a furnace power supply apparatus for the supply of an electric arc furnace or a submerged arc-resistance furnace with electric energy,
wherein the furnace power supply apparatus is connectable to a three-phase power network,
wherein the furnace power supply apparatus is connectable to at least one electrode of the electric arc furnace or the submerged arc-resistance furnace,
wherein the furnace power supply apparatus comprises:
   a three-phase transformer, with a primary circuit per phase and a secondary circuit per phase, in particular exactly one secondary circuit per phase,
   a rectifier circuit, and
   preferably a smoothing circuit connected to the rectifier circuit,
and wherein the three-phase transformer is a phase-shifting transformer.

The following terms are explained in more detail:

First of all, it should be expressly pointed out that in the context of this patent application indefinite articles and figures such as “one”, “two”, etc. should normally be understood as “at least” information, i.e. “at least one . . . ”, “at least two . . . ”, etc., unless it is expressly apparent from the respective context or it is obvious or technically mandatory for the person skilled in the art that only “exactly one . . . ”, “exactly two . . . ”, etc. can be meant.

In the context of this patent application, the term “in particular” should always be understood as meaning that this term introduces an optional, preferential feature. The expression is not to be understood as “namely”.

An “electric arc furnace” is a furnace that uses electric energy provided and/or treated by an “furnace power supply apparatus” to generate an electric arc to melt a metal mass, particularly scrap metal and/or a scrap metal mix and/or direct reduced iron (DRI) and/or hot briquetted iron (HBI) and/or hot metal and/or flux materials, in the electric arc furnace. An electric arc furnace can be a ladle furnace.

The electric arc forms between the charged material and the electrode. The charge of the electric arc furnace is heated both by current passing through the charge and by the radiant energy is evolved by the arc. The electric arc temperature can reach around 3.000° C. or higher.

A “submerged arc-resistance furnace” is a furnace that uses electric energy provided and/or treated by a furnace power supply apparatus to generate arcs between the electrode and the charge material or heats up the charge material by the resistance heating (Joule effect). The charged Materials typically are nonferrous metal, iron alloys, waste recycling, slag and cleaning of slag.

An electric arc furnace or a submerged arc-resistance furnace can have a charge capacity greater than or equal to 1 ton, preferably greater than or equal to 20 ton, and particularly preferably greater than or equal to 50 ton. Further advantageously, an electric arc furnace or a submerged arc-resistance furnace can have a charge capacity greater than or equal to 100 ton, preferably greater than or equal to 200 ton, and particularly preferably greater than or equal to 400 ton.

The furnace power supply apparatus can be connected with the electric arc furnace or a submerged arc-resistance furnace, particularly with an electrode of the electric arc furnace or a submerged arc-resistance furnace and or a furnace transformer, by busbars, which can be cooled with air, gas, water or another appropriate cooling medium which is different than water or gas, by cables or other appropriated electric power transmission medium, like for example graphite or the like.

An “electrode” is an electrical conductor used to make contact with a part of a circuit, particularly an electric arc furnace or a submerged arc-resistance furnace circuit, in particular a nonmetallic part of a circuit. In the case of an electric arc furnace or a submerged arc-resistance furnace, the nonmetallic part of the circuit can correspond to the atmosphere in the electric arc furnace or a submerged arc-resistance furnace.

An electrode can be produced from high density graphite and/or wolfram. An electrode may be designed to transfer electrical energy forming arcs between tip and charge material.

An electrode can be a prebaked electrode or a self-baking electrode (Soederberg electrode) and/or an extrusion/composite electrode, which is a combination of a Soederberg electrode with a prebaked electrode as a core and/or a hollow electrode system, which allows charging of fines via the centre hole (prebaked, self-baking), whereby the selection of the type of electrode can depend on: size of the electrode, produced material/metallurgy, and economic aspects such as operational costs.

An electrode of an electric arc furnace or a submerged arc-resistance furnace may be located at the top of an electric arc furnace or a submerged arc-resistance furnace. Preferably, an electrode located at the top is connected to a height adjustment means, whereby the distance of the electrode to the designated scrap and/or designated molten metal in the electric arc furnace or a submerged arc-resistance furnace can be varied. Such variation can be controlled and/or regulated by an electrode regulator.

Additionally, a second electrode may be disposed in a furnace vessel of the electric arc furnace or a submerged arc-resistance furnace or may be a component of the inner wall of the furnace vessel.

Optionally, a second electrode may also be arranged at the top of the electric arc furnace or a submerged arc-resistance furnace and preferably also be connected to a height adjustment means.

It should be expressly noted that an electric arc furnace or a submerged arc-resistance furnace may also have three, four or more electrodes.

An electric arc furnace or a submerged arc-resistance furnace can be operated by means of direct current or by means of alternating current.

In an electric arc furnace or a submerged arc-resistance furnace operated by direct current, the electrodes may be referred to as anode and cathode. An anode can also be divided into several segments.

An anode, preferably a bottom electrode, is metallic and/or conductive material in the bottom of a furnace and arcs are formed between the charge material and the cathode from top, preferably a cathode made of graphite or carbon.

An alternating current electric arc furnace or a submerged arc-resistance furnace can be powered by a one-phase electrical power supply or a polyphase electrical power supply, in particular a three-phase electrical power supply.

A “transformer” is a component that transfers electrical energy from one electrical circuit to another circuit without a conductive connection between the two circuits. The transformer converts an alternating current (AC) at a primary of the transformer to an AC at a secondary of the transformer.

In the context of this description, the term transformer is synonymous with a three-phase transformer. In other words, a three-phase transformer is always meant here. However, a three-phase transformer can also be understood as a combination of three one-phase transformers.

The transformer may have one or at least one primary circuit per phase and one or at least one secondary circuit per phase. In particular the transformer may comprise exactly one secondary circuit per phase. The transformer can be a dry type power transformer or oil cooled type transformer. Particularly, the transformer can be also cooled with other appropriate cooling fluid or gas.

In particular, the voltage on the secondary side may be 1,000 V or less than 1,000 V or more than 1,000 V.

The transformer can be a high-voltage to medium-voltage transformer transforming a high-voltage at a primary of the transformer to a medium-voltage at a secondary of the transformer.

The transformer can be a high-voltage to low-voltage transformer transforming a high-voltage at a primary of the transformer to a low-voltage at a secondary of the transformer.

The transformer can be a medium-voltage to medium-voltage transformer transforming a medium-voltage at a primary of the transformer to a medium-voltage at a secondary of the transformer.

The transformer can be a medium-voltage to low-voltage transformer transforming a medium-voltage at a primary of the transformer to a low-voltage at a secondary of the transformer. The transformer can be connected to a power supply network at the primary of the transformer.

High-voltage can be greater than or equal to 36 kV, preferably greater than or equal to 60 kV, and particularly preferably greater than or equal to 100 kV. Further advantageously, medium-voltage can be greater than or equal to 150 kV, preferably greater than or equal to 200 kV, and particularly preferably greater than or equal to 300 kV. Medium-voltage can be less than or equal to 400 kV. Further advantageously, medium-voltage can be less than or equal to 300 kV, preferably less than or equal to 200 kV, and particularly preferably less than or equal to 150 kV.

Medium-voltage can be greater than or equal to 1 kV alternating current or greater than or equal to 1.5 kV direct current, preferably greater than or equal to 2 kV, and particularly preferably greater than or equal to 10 kV. Further advantageously, medium-voltage can be greater than or equal to 15 kV, preferably greater than or equal to 20 kV, and particularly preferably greater than or equal to 30 kV. Medium-voltage can be less than or equal to 36 kV. Further advantageously, medium-voltage can be less than or equal to 30 kV, preferably less than or equal to 20 kV, and particularly preferably less than or equal to 15 kV.

Low-voltage can be greater than or equal to 50 V, preferably greater than or equal to 60 V, and particularly preferably greater than or equal to 100 V. Further advantageously, low-voltage can be greater than or equal to 120 V, preferably greater than or equal to 220 V, and particularly preferably greater than or equal to 240 V. Low-voltage can be less than or equal to 1.000 V, and particularly preferably less than or equal to 900 V. Further advantageously, low-voltage can be less than or equal to 600 V, preferably less than or equal to 240 V, and particularly preferably less than or equal to 220 V. Preferably, voltage levels for an electric arc furnace or a submerged arc-resistance furnace can be defined according to IEC 60519-4.

A “phase-shifting transformer” is a specialized type of transformer, which can be configured to adjust the phase relationship between its primary circuits (primary) and its secondary circuits (secondary), which allows to control the power flow on a three-phase electric transmission network.

The phase angle of a three-phase transformer is a function of a vector group of the three-phase transformer.

A vector group, elsewhere defined by a connection symbol, is the International Electrotechnical Commission (IEC) method of categorizing primary winding, preferably high voltage (HV) winding, and secondary winding, preferably low voltage (LV) winding, configurations of three-phase transformers. The vector group designation indicates the windings configurations and the difference in phase angle between them.

A vector group provides a simple way of indicating how the connections of a transformer are arranged. Different configurations are possible as to how the primary windings, preferably MV windings, and the secondary windings, preferably LV windings, are connected to each other. In particular, they can be connected to each other in a delta circuit, a star circuit or a zigzag circuit, whereby primary windings, preferably MV windings, and secondary windings, preferably LV windings, can each be connected differently, resulting in a phase-shift between the primary side and the secondary side of the phase-shifting transformer.

For example, a star MV winding and a delta LV winding may be combined to form a vector group and will result in a 30-degree phase-shift between the primary side and the secondary side.

By advantageous selection of the vector group, the total harmonic distortion injected in the network can be minimized.

Total harmonic distortion (THD) can be defined as the ratio of the root mean square (RMS) amplitude of a set of higher harmonic frequencies to the RMS amplitude of the first harmonic or fundamental frequency. It can be calculated with the following formula:

$${THD}_{Y} = \frac{\sqrt{{\sum }_{h = 2}^{∞} {Y}_{h}^{2}}}{{Y}_{1 , RMS}}$$

where:
THD_{Y}=Total harmonic distortion of the signal Y
Yₕ=amplitude of the h^{th} harmonic
Y_{1,RMS}=RMS value of the amplitude of fundamental frequency

The electrical load on the three-phase power network during operation of an electric arc furnace or a submerged arc-resistance furnace can be asymmetrical, causing a harmonic distortion of the three-phase power network. The total harmonic distortion of the three-phase power network can be influenced by selecting the vector group of the three-phase transformer. In particular, the total harmonic distortion caused in the three-phase power network can be minimized by using a phase-shifting transformer.

A three-phase transformer can have one or more sets of secondary windings. If the transformer has several sets of secondary windings, the power can be divided among the existing sets of secondary windings. Between the primary windings, preferably MV windings, and each set of secondary windings, preferably LV windings, a different vector group can be advantageously selected so that the electrical power can be transmitted with different phase offsets. Depending on the number of sets of secondary windings, the individual phase shift can advantageously be selected in such a way that a harmonic course of the phases results with a simultaneous increase in the number of pulses provided. Using more than one set of secondary windings can also improve the total harmonics of the power network.

The portion of instantaneous power that results in net transfer of energy in one direction is known as instantaneous “active power”. The portion of instantaneous power that results in no net transfer of energy but instead oscillates between the source and load in each cycle due to stored energy, is known as instantaneous “reactive power”.

The phase angle can be influenced by the phase-shifting transformer in a range of less than or equal to plus/minus 5° primary to secondary phase shift, preferably in a range of less than or equal to plus/minus 10° and particularly preferably in a range of less than or equal to plus/minus 15°. Furthermore, the phase angle can preferably be influenced by the phase-shifting transformer in a range of less than or equal to plus/minus 20° primary to secondary phase shift, preferably in a range of less than or equal to plus/minus 25° and particularly preferably in a range of less than or equal to plus/minus 30°. Furthermore, the phase angle can preferably be influenced by the phase-shifting transformer in a range of less than or equal to plus/minus 35° primary to secondary phase shift, preferably in a range of less than or equal to plus/minus 40° and particularly preferably in a range of less than or equal to plus/minus 450 primary to secondary phase shift. The above phase shift values are to be understood as being read between the closest adjacent upper or lower reversal points of the AC waveforms of the primary and the phase shifted secondary.

A phase-shifting transformer is a simple, robust and reliable technology.

A “rectifier circuit” is an electrical device that converts alternating current, which periodically reverses direction, to direct current, which flows in only one direction.

A rectifier circuit can be a three-phase rectifier circuit.

The rectifier circuit can have a topology comprising and/or consisting of diodes. A three-phase rectifier circuit can be an uncontrolled n times 6 pulse diode rectifier circuit, in particular a 6 pulse diode rectifier circuit, a 12 pulse diode rectifier circuit, a 18 pulse diode rectifier circuit and so on.

By using transistors and/or thyristors, a rectifier circuit can be controlled or regulated.

The rectifier can be high current fuse protected.

Deriving a direct current voltage within a power supply, particularly within a furnace power supply apparatus, from an alternating current source usually leads to a ripple voltage. The ripple voltage is a residual periodic variation.

To smooth the ripple voltage, the rectifier circuit is connected to a “smoothing circuit”, which is set up to straighten the ripple voltage.

The smoothing circuit can have a capacitor bank connected in parallel to the rectifier circuit.

The smoothing circuit can have an inductance bank, which is connected in series with the rectifier circuit.

Electric arc furnaces or a submerged arc-resistance furnaces represent a highly nonlinear load. Such nonlinear load can cause flicker and/or harmonic distortion in the power network connected to the electric arc furnace or a submerged arc-resistance furnace.

It is proposed here to control the amount of total harmonic distortion (THD) using a phase-shifting transformer, particularly to reduce the amount of THD. This can significantly reduce grid disturbances and, at the same time, improve the efficiency of use of the energy provided by the power network, because THD can be minimized or prevented.

It is further preferably proposed that the phase-shifting transformer be located between the three-phase power network and the rectifier circuit. Advantageously, this allows the furnace power supply apparatus to have take over points between the power network and a direct current bus. Thus, a multi-purpose usability of the furnace power supply apparatus proposed here can be achieved. In particular, the furnace power supply apparatus can be applied according to a first variant in combination with a chopper circuit to power a DC-powered electric arc furnace or a DC-powered submerged arc-resistance furnace or according to a second variant in combination with an inverter circuit to power an AC-powered electric arc furnace or an AC-powered submerged arc-resistance furnace. Accordingly, the existing systems do not have the modularity and multi-purpose usability that can be achieved here.

Thus, a particularly advantageous modular design of the furnace power supply apparatus can be achieved, which does not require separate modifications for the reduction of total harmonic distortion.

To increase the power that can be supplied to a phase of an electric arc furnace or a submerged arc-resistance furnace, the above variants of a furnace power supply apparatus can be connected together by means of a parallel circuit. In the case of a DC-powered electric arc furnace or a DC-powered submerged arc-resistance furnace, the furnace power supply apparatuses can be connected in parallel with each other by means of a cathode busbar and an anode busbar.

In a parallel connection of a plurality of power supply apparatuses, a plurality of groups each consisting of a phase-shifting transformer and a rectifier may be connected in parallel, which are connected to a common smoothing circuit. Further, in a parallel connection of a plurality of power supply apparatuses, a plurality of groups each comprising a phase-shifting transformer, a rectifier and a smoothing circuit may be connected in parallel.

When several furnace power supply apparatuses are connected in parallel, they are completely independent of each other, but can be interconnected by a common electronic coordination and regulation unit with regard to individual control or regulation. Furthermore each furnace power supply apparatus of a parallel connection of several furnace power supply apparatuses can feature a different phase shift.

Depending on the number of furnace power supply apparatuses connected in parallel, the individual phase shift of each apparatus can be advantageously selected in such a way that a harmonic course of the phases results with a simultaneous increase in the number of pulses provided. This can significantly reduce the extent of total harmonic distortion caused in the power network by the operation of an electric arc furnace or a submerged arc-resistance furnace.

For the operation of a polyphase electric arc furnace or a polyphase submerged arc-resistance furnace, in particular a three-phase AC-powered electric arc furnace or a three-phase AC-powered submerged arc-resistance furnace, a parallel connection of a plurality of one of the above variants providing a third variant of the furnace power supply apparatus can be used, wherein different sub-variants are possible here. Thereby, each subset of a single furnace power supply apparatus or a paralleled arrangement of furnace power supply apparatuses can provide a is phase of the polyphase system. The phase shift, expressed in radians, between each phase of the polyphase system featuring an advantageously harmonic course of the phases can be calculated with the formula:

$$PS = 2 * PI / N$$

where:
PS=phase shift (radians)
PI=3,141592 . . .
N=number of phases

For an arrangement for operating a polyphase AC-powered electric arc furnace or a polyphase AC-powered submerged arc-resistance furnace, each phase can comprise an equal number of furnace power supply apparatuses connected in parallel with each other.

The modularity and multi-purpose usability achieved here can further significantly reduce maintenance and overall spare parts inventory costs.

In an expedient embodiment the primary of the transformer is connectable to the three-phase power network and the secondary of the transformer is directly connected to the rectifier circuit.

According to a preferred embodiment the furnace power supply apparatus comprises an electronic control unit, which is connectable to an electronic coordination and regulation unit, whereby the electronic control unit is operatively connected to the rectifier circuit and adapted to regulate the active power flow of the furnace power supply apparatus.

The following terms are explained in more detail:

An “electronic control unit” is any electronic system, which is adapted to receive signals and/or to store signals and/or to process signals and/or to control or regulate a furnace power supply apparatus in dependence on at least one signal.

The furnace power supply apparatus can include one or more sensors to provide information about harmonic distortions and/or flicker and/or a ratio of active power flow and reactive power flow in the power network. The electronic control unit can be operatively connected to one or more such sensors and can receive sensor signals, process them, and use them to control or regulate the furnace power supply apparatus.

An electronic control unit can be arranged to control or regulate a rectifier circuit, in particular to reduce or prevent harmonic distortions and/or flicker, in particular to mitigate flicker, in the power network.

An electronic control unit can be arranged to control or regulate a rectifier circuit, in particular to optimize the ratio of active power flow and reactive power flow in the power network.

An electronic control unit can be arranged to control or regulate a chopper circuit or an inverter circuit, in particular to reduce or prevent harmonic distortions and/or flicker, in particular to mitigate flicker, in the power network, in particular preferably by applying a pulse-width modulation strategy algorithm.

A pulse-width modulation strategy algorithm (PWM) is a method of reducing the average power delivered by an electrical signal, by effectively chopping it up into discrete parts. The average value of voltage and/or current fed to a load can be controlled by turning the switch between supply and load on and off at a fast rate. The longer the switch is on, compared to the off periods, the higher the total power supplied to a load. This results in a discrete signal to the load. It is advantageous if the PWM switching frequency is high, especially high enough not to affect the load. In other words, the smoother the resultant waveform perceived by the load, the better for the load. The rate or frequency at which a PWM switching frequency is operated depends on the load.

An “electronic coordination and regulation unit” is any electronic system, which is adapted to communicate with one or more electronic control units. Preferably, the electronic coordination and regulation unit is adapted to communicate with one or more electrode regulators, in particular aiming to reduce harmonic distortion and/or reduce flicker, in particular to mitigate flicker, and/or improve power factor.

An electronic coordination and regulation unit can be arranged to take over a superordinate control or regulation of the connected partial regulators in a system of furnace power supply apparatuses, in particular one or more connected electronic control units and/or one or more electrode regulators.

The electronic coordination and regulation unit can control or regulate the voltage setpoint of one or several furnace power supply apparatuses.

The electronic coordination and regulation unit can control or regulate the current setpoint of one or several furnace power supply apparatuses.

The electronic coordination and regulation unit can control or regulate the active power setpoint of one or several furnace power supply apparatuses.

The electronic coordination and regulation unit can control or regulate the reactive power setpoint of one or several furnace power supply apparatuses.

The electronic coordination and regulation unit can control or regulate the frequency setpoint of one or several furnace power supply apparatuses.

The electronic coordination and regulation unit can control or regulate the impedance or resistance setpoint of one or several furnace power supply apparatuses.

The electronic coordination and regulation unit can control or regulate the power factor, in particular improve the power factor, of one or several furnace power supply apparatuses.

The electronic coordination and regulation unit can coordinate a single electrode regulator or multiple electrode regulators of one or several AC furnace power supply apparatuses.

By controlling and/or regulating the rectifier circuit, harmonic distortion and/or flicker can be reduced.

In an optional embodiment the furnace power supply apparatus comprises a chopper circuit connected to the smoothing circuit.

The following terms are explained in more detail:

A “chopper circuit” is an electronic switching circuit that is used to interrupt one signal under the control of another. The chopper circuit can be used for converting fixed DC input to a variable DC output voltage directly.

Since a switching element in the chopper circuit is either fully on or fully off, its losses are low and the chopper circuit can provide high efficiency. A high switching rate of greater than or equal to 100 Hz, preferably a switching rate of greater than or equal to 600 Hz, and particularly preferably a switching rate of greater than or equal to 1.000 Hz can advantageously be used to stabilize an electric arc and to protect the furnace power supply apparatus from a possible drift.

An “H-bridge” and/or a “half H-bridge” is a well known electronic circuit that switches the polarity of a voltage applied to a load.

A chopper circuit can comprise a half H-bridge, particularly eight half H-bridges.

A chopper circuit can be used to reduce or prevent the flicker, in particular to mitigate the flicker, in the power network by controlling the control signals for the switches of the chopper circuit, particularly in connection with the electronic control unit.

Optionally the furnace power supply apparatus comprises an inverter circuit connected to the smoothing circuit.

The following terms are explained in more detail:

An “inverter circuit” is a power electronic device or circuitry that changes direct current (DC) to alternating current (AC). The resulting AC frequency obtained depends on the switching algorithm.

An inverter circuit can be controlled by applying a pulse-width modulation strategy algorithm.

An inverter circuit can comprise an H-bridge, particularly four H-bridges.

An inverter circuit can be used to reduce or prevent the flicker, in particular to mitigate flicker, in the power network by controlling the control signals for the switches of the inverter circuit, particularly in connection with the electronic control unit.

According to a preferred embodiment the rectifier circuit and/or the chopper circuit and/or the inverter circuit comprises at least one semiconductor element comprising silicon carbide.

The following terms are explained in more detail:

A “semiconductor element” comprises an electrical conductivity value falling between that of a conductor, such as metallic copper, and an insulator, such as glass. A semiconductor element can be used for amplification, switching, and energy conversion.

A first embodiment of a semiconductor element is a diode.

A second embodiment of a semiconductor element is a transistor, preferably an insulated gate bipolar transistor (IGBT).

A third embodiment of a semiconductor element is a thyristor.

Advantageously a semiconductor switch, particularly a transistor or a thyristor, comprises a switching rate of greater than or equal to 100 Hz, preferably a switching rate of greater than or equal to 600 Hz, and particularly preferably a switching rate of greater than or equal to 1.000 Hz.

Through the use of silicon carbide, various advantages can be made possible.

Silicon carbide can have a wide bandgap of greater than or equal to 3 eV, can be used stably up to high operating temperatures of 150° C., can have a particularly high thermal conductivity, in particular a thermal conductivity three times higher than the thermal conductivity of silicon, allowing semiconductor elements made of silicon carbide to be cooled better and faster in comparison.

Furthermore, by using silicon carbide, a ten times higher electric field strength with a higher maximum current and a better efficiency of the semiconductor element can be achieved compared to silicon.

Overall, a rectifier circuit and/or a chopper circuit and/or an inverter circuit can be achieved which has lower losses, can be operated at higher ambient temperatures, thus reducing cooling requirements, can be operated at higher operating voltages and higher switching frequencies.

Furthermore, higher reliability and availability of the rectifier circuit and/or the chopper circuit and/or the inverter circuit can be achieved when using silicon carbide, since silicon carbide is particularly insensitive to radiation, especially to the electromagnetic radiation of an electric arc furnace or the electromagnetic radiation of a submerged arc-resistance furnace, compared to other semiconductor materials, especially silicon.

By using silicon carbide semiconductor switches, a particularly compact and/or efficient design can be achieved.

Expediently the furnace power supply apparatus comprises a three-phase disconnector for alternating current.

The following terms are explained in more detail:

A “disconnector” is a switching element ensuring that an electrical circuit is completely de-energized for service or maintenance. A three-phase disconnector comprises three phases.

Optionally the furnace power supply apparatus comprises a one-phase disconnector.

Preferably, the disconnector is located between a designated connection of electrode and inverter circuit or chopper circuit.

By means of the disconnectors proposed here, it can be ensured that the furnace power supply apparatus can be switched voltage-free, whereby maintenance work can be carried out safely.

Preferably, the disconnectors will connect the furnace power supply apparatus to ground potential in open position. This will increase the safety for maintenance work.

Furthermore, in a system comprising a plurality of furnace power supply apparatuses, it is possible to completely separate each furnace power supply apparatus from the rest of the system, without basically affecting the whole functionality of the system.

According to a preferred embodiment the electric furnace power supply apparatus comprises an electronic control unit, which is connectable to an electronic coordination and regulation unit, whereby the electronic control unit is adapted to control a current loop and/or a voltage loop and/or impedance loop and/or active power loop and/or active power with hysteresis loop of the furnace power supply apparatus.

For this purpose, the electronic control unit can be set up to be operatively connected to the rectifier circuit and/or the chopper circuit and/or the inverter circuit and to be able to influence the respective control quantities.

Preferably, the electronic control unit uses an algorithm for a pulse-width modulation strategy, preferably a synchronous, an asynchronous or an interleaved pulse-width modulation strategy.

According to a second aspect of the invention, the task is solved by a system for the supply of two electrodes of an electric arc furnace or a submerged arc-resistance furnace with electric energy,
wherein the system is connectable to a three-phase power network,
wherein the system is connectable to the electrode of the electric arc furnace or the submerged arc-resistance furnace,
wherein the system comprises a plurality of furnace power supply apparatuses according to the first aspect of the invention, and
wherein the plurality of furnace power supply apparatuses are connected in parallel to each other.

It is understood that the advantages of a furnace power supply apparatus according to the first aspect of the invention, as described above, transfer directly to a system comprising a furnace power supply apparatus according to the first aspect of the invention.

Especially for the provision of a higher connected load, it is advantageous to connect a plurality of furnace power supply apparatuses in parallel.

This approach automatically leads to a higher number of phase-shifting transformers and thus advantageously also to a larger number of control options to reduce harmonic distortion.

In particular, it should be kept in mind that the plurality of phase-shifting transformers of the plurality of furnace power is supply apparatuses may have different vector groups, in particular, each may have a different vector group.

In this way, a different phase-shift can be provided by each furnace power supply apparatus, which can also increase the number of pulses provided by the system. In sum, the harmonic distortion can thus be reduced.

A system can preferably have two furnace power supply apparatuses, each with a different vector group, whereby the number of pulses can be doubled compared to a single furnace power supply apparatus of the same design.

A system can preferably have three furnace power supply apparatuses, each with different vector groups, whereby the number of pulses can be tripled compared to a single furnace power supply apparatus of the same design.

A system can preferably have four furnace power supply apparatuses, each with different vector groups, whereby the number of pulses can be quadrupled compared to a single furnace power supply apparatus of the same design.

A system can preferably have five furnace power supply apparats uses, each with different vector groups, whereby the number of pulses can be quintupled compared to a single furnace power supply apparatus of the same design.

A system can preferably have six furnace power supply apparatuses, each with different vector groups, whereby the number of pulses can be increased sixfold compared to a single furnace power supply apparatus of the same design.

For example, a system having six electric power supply apparatuses may preferably be configured such that the first electric power supply apparatus provides a phase shift such that a pulse lags the phase of the power network by 25°. Furthermore, the second electric power supply apparatus can provide a phase-shift so that a pulse lags the phase position of the power network by 15°. The third electric power supply apparatus can provide a phase shift so that a pulse lags the phase of the power network by 5°. The fourth electric power supply apparatus can provide a phase-shift so that a pulse leads the phase of the power network by 5°. The fifth electric power supply apparatus can provide a phase-shift so that a pulse leads the phase of the power network by 15°. The sixth electric power supply apparatus can provide a phase-shift such that a pulse leads the phase of the power network by 25°.

In total, a harmonic distribution of the 36 different pulses can be achieved, especially of the 36 different pulses that can be detected behind the rectifier. This is particularly advantageous for reducing the harmonic distortion.

It should be expressly noted that this teaching can also be adapted analogously to a different number of power supply apparatuses.

It should be noted that the subject-matter of the second aspect can be advantageously combined with the subject-matter of the preceding aspect of the invention, either individually or cumulatively in any combination.

According to a third aspect of the invention, the task is solved by a system for the supply of a plurality of electrodes of an electric arc furnace or a submerged arc-resistance furnace with electric energy,
wherein the system is connectable to a three-phase power network,
wherein the system is connectable to the plurality of electrodes of the electric arc furnace or the submerged arc-resistance furnace,
wherein the system comprises a plurality of systems for the supply of one electrode according to the second aspect of the invention, and
each system for the supply of one electrode being connectable to one of the plurality of electrodes.

Here, it is proposed for a polyphase electric arc furnace or a polyphase submerged arc-resistance furnace to combine a plurality of systems according to the second aspect of the invention, wherein each system according to the second aspect of the invention is connectable to exactly one electrode of the polyphase electric arc furnace or the polyphase submerged arc-resistance furnace.

Among other things, the system proposed herein can be advantageously used to provide electrical power to a polyphase AC-powered electric arc furnace or a polyphase AC-powered submerged arc-resistance furnace.

It is understood that the advantages of system for the supply of one electrode of an electric arc furnace or a submerged arc-resistance furnace with electric energy according to the second aspect of the invention, as described above, transfer directly to a system comprising such system according to the second aspect of the invention.

It should be noted that the subject-matter of the third aspect can be advantageously combined with the subject-matter of the preceding aspects of the invention, either individually or cumulatively in any combination.

According to a fourth aspect of the invention, the task is solved by a system for the supply of a plurality of electrodes of an electric arc furnace or a submerged arc-resistance furnace with electric energy,
wherein the system is connectable to a three-phase power network,
wherein the system is connectable to the plurality of electrodes of the electric arc furnace or the submerged arc-resistance furnace,
wherein the system comprises a plurality of furnace power supply apparatuses according to the first aspect of the invention,
wherein a first number of at least two furnace power supply apparatuses is connected in parallel to each other and is connectable to a first electrode, and
wherein at least one furnace power supply apparatus is connectable to a second electrode.

Among other things, the system proposed herein can be advantageously used to provide electrical power to a polyphase AC-powered electric arc furnace or a polyphase AC-powered submerged arc-resistance furnace.

It is understood that the advantages of a furnace power supply apparatus according to the first aspect of the invention, as described above, transfer directly to a system comprising a furnace power supply apparatus according to the first aspect of the invention.

In an expedient embodiment the system is connectable to three electrodes of an electric arc furnace or a submerged arc-resistance furnace with a star connection or a delta connection.

In a preferred embodiment the system comprises an electrode regulator, preferably one electrode regulator per electrode.

The following terms are explained in more detail:

The electrodes can be raised and lowered automatically by a positioning system and/or by a handling system, which can use either electric winch hoists or hydraulic cylinders or the like. The position of an electrode can be controlled and/or regulated by means of an “electrode regulator”. The electrode regulator can pursue different objectives individually or in combination, particularly maintaining approximately constant voltage and/or constant current and/or power input during the melting of the charge, even though scrap may move under the electrodes as it melts. A length of the arc can increase with increasing voltage supplied to the electric arc furnace or the submerged arc-resistance furnace.

In this way, an electrode regulator supports the system in reducing or preventing flicker, in particular mitigating flicker, in the power network.

Expediently the system comprises an electronic coordination and regulation unit which is operatively connected to an electronic control unit and/or an electrode regulator, preferably operatively connected to each electronic control unit and/or each electrode regulator.

By means of the electronic coordination and regulation unit it can be advantageously achieved that a multitude of individual control and/or regulation possibilities can be used collectively to achieve an overall objective, in particular to reduce or avoid flicker, in particular to mitigate flicker, in the power network and preferably to maximize the energy transfer to scrap the melt.

It should be noted that the subject-matter of the fourth aspect can be advantageously combined with the subject-matter of the preceding aspects of the invention, either individually or cumulatively in any combination.

According to a fifth aspect of the invention, the task is solved by an electric arc furnace or a submerged arc-resistance furnace comprising a furnace power supply apparatus according to the first aspect of the invention and/or a system according to the second aspect of the invention and/or the third aspect of the invention and/or the fourth aspect of the invention.

It is understood that the advantages of a furnace power supply apparatus according to the first aspect of the invention and/or a system according to the second aspect of the invention and/or the third aspect of the invention and/or the fourth aspect of the invention, as described above, transfer directly to an electric arc furnace or a submerged arc-resistance furnace comprising a furnace power supply apparatus according to the first aspect of the invention and/or a system according to the second aspect of the invention and/or the third aspect of the invention and/or the fourth aspect of the invention.

It should be noted that the subject-matter of the fifth aspect can be advantageously combined with the subject-matter of the preceding aspects of the invention, either individually or cumulatively in any combination.

According to a sixth aspect of the invention, the task is solved by a method for operating an electric arc furnace or a submerged arc-resistance furnace, in particular an electric arc furnace or a submerged arc-resistance furnace according to the fifth aspect of the invention, wherein the ratio of active power flow and reactive power flow is controlled and/or regulated by influencing a control quantity of a rectifier circuit, in particular the reactive power flow is minimized by influencing a control quantity of the rectifier circuit.

It is understood that the advantages of an electric arc furnace or a submerged arc-resistance furnace according to the fifth aspect of the invention, as described above, transfer directly to a method for operating an electric arc furnace or a submerged arc-resistance furnace according to the fifth aspect of the invention.

It should be noted that the subject-matter of the sixth aspect can be advantageously combined with the subject-matter of the preceding aspects of the invention, either individually or cumulatively in any combination.

Remaining harmonics can be further reduced or filtered by reactor-capacitor banks connected parallel to the furnace power supply apparatus on the same supply network.

Flicker values can be further reduced by an static reactive power compensator (SVC) or static synchronous compensator (STATCOM) system connected parallel to the furnace power supply apparatus on the same supply network. In an optional embodiment, the furnace power supply apparatus work together with the SVC control system or STATCOM control system in a collaborative manner.

Further advantages, details and features of the present invention are explained in the description of the following embodiments, thereby:

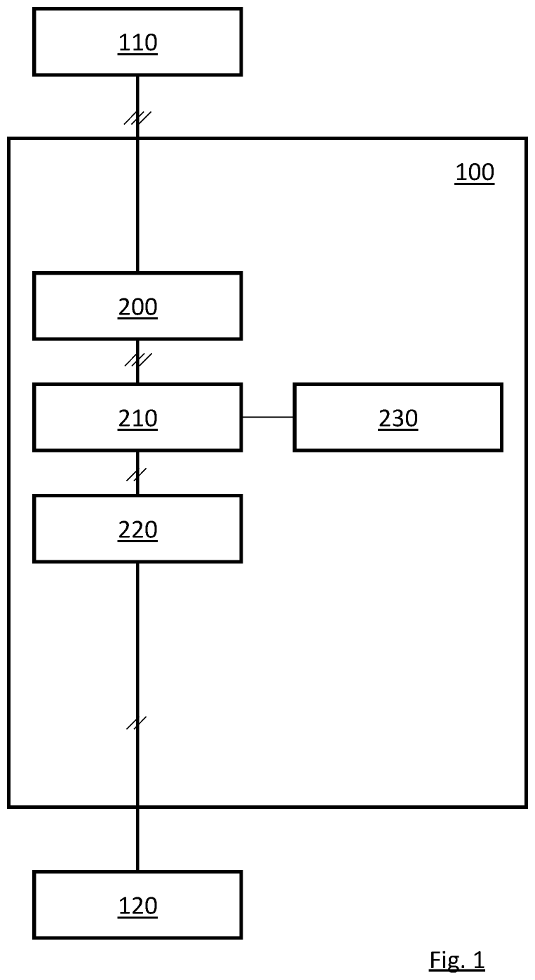

FIG. 1: shows a schematic view of a first embodiment of a furnace power supply apparatus;

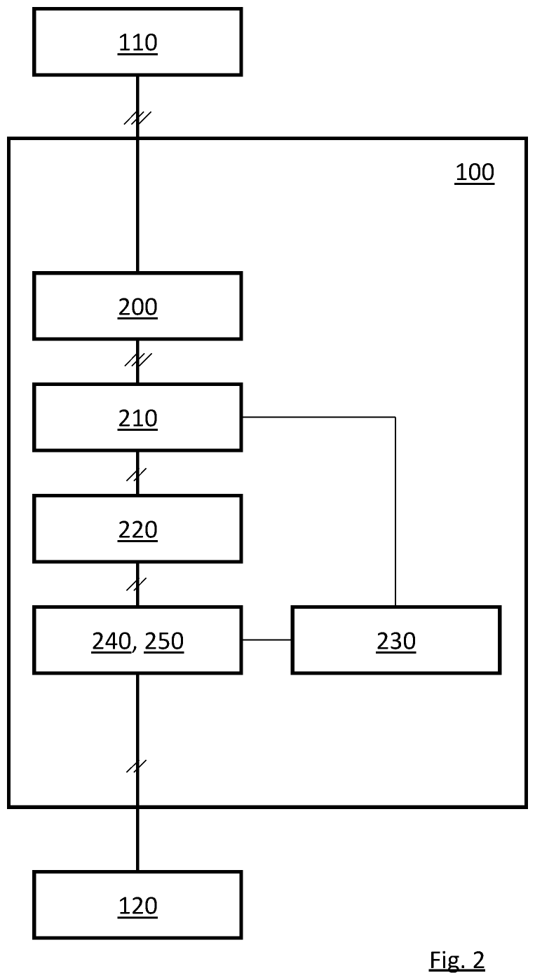

FIG. 2: shows a schematic view of a second embodiment of a furnace power supply apparatus;

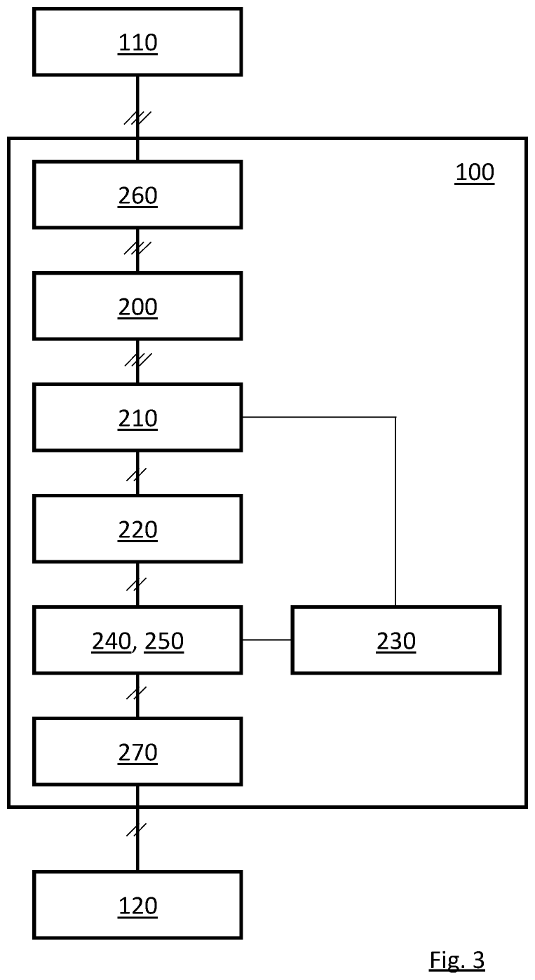

FIG. 3: shows a schematic view of a third embodiment of a furnace power supply apparatus;

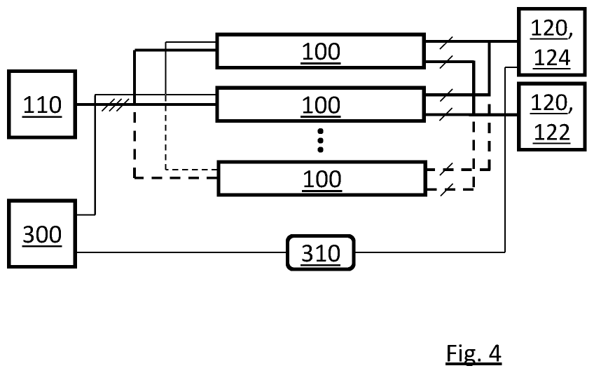

FIG. 4: shows a schematic view of an embodiment of a system for the supply of one electrode of a DC-powered electric arc furnace or a DC-powered submerged arc-resistance furnace with electric energy;

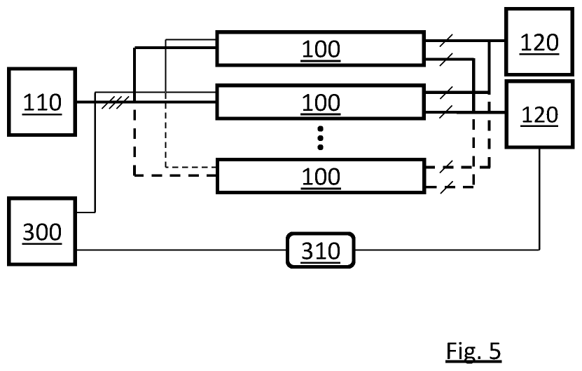

FIG. 5: shows a schematic view of a first embodiment of a system for the supply of a one-phase AC-powered electric arc furnace or a one-phase AC-powered submerged arc-resistance furnace with electric energy;

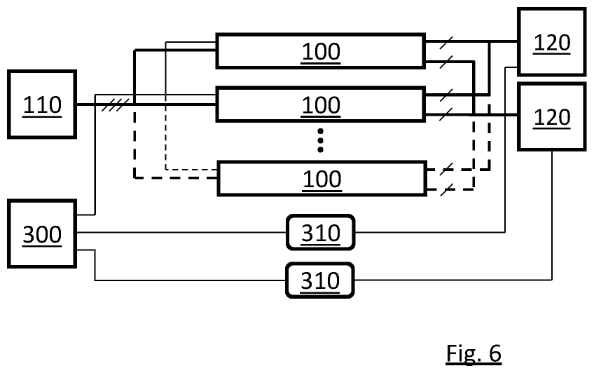

FIG. 6: shows a schematic view of a second embodiment of a system for the supply of a one-phase AC-powered electric arc furnace or a one-phase AC-powered submerged arc-resistance furnace with electric energy; and

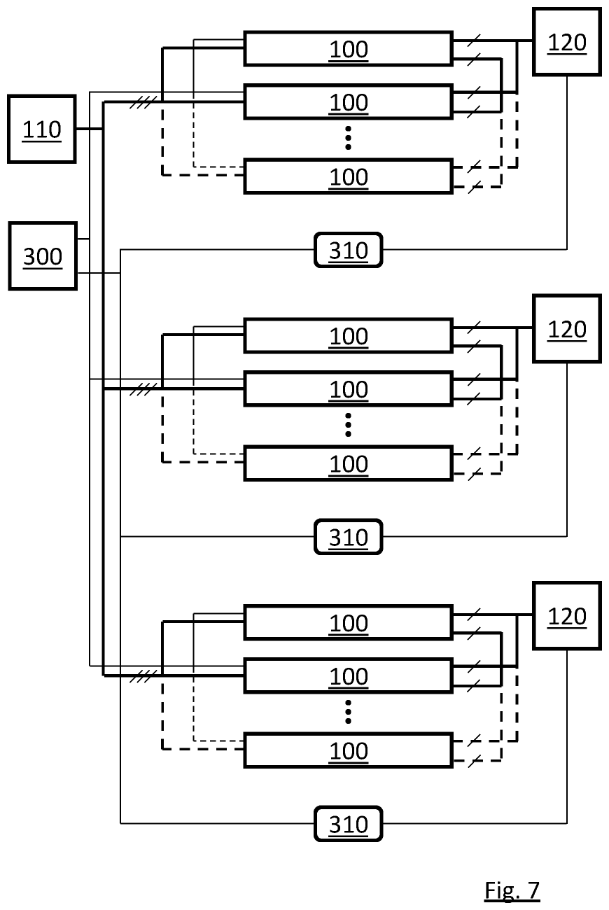

FIG. 7: shows a schematic view of an embodiment of a system for the supply of a three-phase AC-powered electric arc furnace or a three-phase AC-powered submerged arc-resistance furnace with electric energy.

In the following description same reference numerals describe same elements and same features, respectively, so that a description of one element conducted with reference to one figure is also valid for the other figures, so that repetition of the respective feature is omitted.

A furnace power supply apparatus 100 in FIG. 1 consists essentially of a transformer 200, being a three-phase phase-shifting transformer 200, a rectifier circuit 210, a smoothing circuit 220 connected to the rectifier circuit 210, and an electronic control unit 230, connected to the rectifier circuit 210.

The furnace power supply apparatus 100 is connectable to a three-phase power network 110. Furthermore the furnace power supply apparatus 100 is connectable to two electrodes 120.

According to one embodiment, a first electrode 120 may be arranged at the top of the designated electric arc furnace or the designated submerged arc-resistance furnace, in particular it may be connected to a height adjustment means (not shown) which is operatively connected to an electrode regulator (not shown) for the first electrode 120. The second electrode 120 may be disposed within the designated electric arc furnace or the designated submerged arc-resistance furnace (not shown) where it is in an operatively connected with a designated scrap (not shown) and/or a designated molten metal (not shown) within the electric arc furnace or the submerged arc-resistance furnace.

The electronic control unit 230 is set up to control and/or regulate the rectifier circuit 210.

A furnace power supply apparatus 100 in FIG. 2 further comprises an inverter circuit 240 or a chopper circuit 250, depending whether the furnace power supply apparatus 100 is intended to use for an AC-powered or a DC-powered electric arc furnace or a AC-powered or a DC-powered submerged arc-resistance furnace (not shown).

The inverter circuit 240 or the chopper circuit 250 is operatively connected to the electronic control unit 230 controlling or regulating the inverter circuit 240 or the chopper circuit 250.

A furnace power supply apparatus 100 in FIG. 3 further comprises a three-phase disconnector or a circuit breaker 260 and/or a one-phase disconnector 270.

By means of a three-phase disconnector or a circuit breaker 260 the furnace power supply apparatus 100 can be connected or disconnected to the three-phase power network 110. By means of a one-phase disconnector 270, the furnace power supply apparatus 100 can be connected or disconnected to an electrode 120 of the electric arc furnace or the submerged arc-resistance furnace (not shown). Preferably, the disconnectors 260, 270 will connect the furnace power supply apparatus to ground potential in open position. This will increase the safety for maintenance work.

A system (not marked) for the supply of two electrodes 120 of a DC-powered electric arc furnace or a DC-powered submerged arc-resistance furnace (not shown) with electric energy in FIG. 4 consists essentially of two or more furnace power supply apparatuses 100 connected in parallel to each other.

An anode 124 of the DC-powered electric arc furnace or a DC-powered submerged arc-resistance furnace (not shown) is connected via an anode busbar (not marked) with the plurality of furnace power supply apparatuses 100. A cathode 122 of the DC-powered electric arc furnace or the DC-powered submerged arc-resistance furnace (not shown) is connected via a cathode busbar (not marked) with the plurality of furnace power supply apparatuses 100.

The plurality of furnace power supply apparatuses 100 is connected to a three-phase power network 110.

Furthermore, the plurality of furnace power supply apparatuses 100 is connected to an electronic coordination and regulation unit 300.

An electrode regulator 310 is connected with the electronic coordination and regulation unit 300 and operatively connected to a height adjustment means (not shown) of the cathode 122.

The anode 124 is located inside the electric arc furnace or the submerged arc-resistance furnace and is in electrical contact with the designated scrap (not shown) and/or a designated molten metal (not shown) within the electric arc furnace or the submerged arc-resistance furnace (not shown).

According to a variant (not shown) to the embodiment of a system for the supply of at least two electrodes of a DC-powered electric arc furnace or a DC-powered submerged arc-resistance furnace with electric energy according to FIG. 4, the system comprises two or more cathodes, wherein each cathode is connected to a combined or to individual height adjustment means and wherein each height adjustment means is operatively connected to a separate electrode regulator. The anode is located inside the designated electric arc furnace or the designated submerged arc-resistance furnace and is in electrical contact with the designated scrap and/or a designated molten metal within the electric arc furnace or the submerged arc-resistance furnace.

A system (not marked) for the supply of two electrodes 120 of a one-phase AC-powered electric arc furnace or a one-phase AC-powered submerged arc-resistance furnace (not shown) with electric energy in FIG. 5 consists essentially of two or more furnace power supply apparatuses 100 connected in parallel to each other.

A first electrode 120 may be arranged at the top of the designated electric arc furnace or the designated submerged arc-resistance furnace, in particular it may be connected to a height adjustment means (not shown), which is operatively connected to an electrode regulator 310 for the first electrode 120.

A second electrode 120 is arranged within the electric arc furnace or the submerged arc-resistance furnace (not shown) and operatively connected to the designated scrap metal and/or a designated molten metal within the electric arc furnace or the submerged arc-resistance furnace.

An electrode regulator 310 is connected with the electronic coordination and regulation unit 300 and operatively connected to the height adjustment means (not shown) of the first electrode 120 of the one-phase electric arc furnace or the one-phase submerged arc-resistance furnace (not shown).

A system (not marked) for the supply of two electrodes 120 of a one-phase AC-powered electric arc furnace or a one-phase AC-powered submerged arc-resistance furnace (not shown) with electric energy in FIG. 6 exhibits two electrodes 120, each of which is connected to a separate height adjustment means (not shown).

In this embodiment, both electrodes 120 are approached from above to a designated scrap and/or a molten metal within the one-phase AC-powered electric arc furnace or the one-phase AC-powered submerged arc-resistance furnace by the height adjustment means. Each height adjustment means is operatively connected to a respective electrode regulator 310.

Three one-phase systems (not marked) for the supply of one electrode 120 of an AC-powered electric arc furnace or a one-phase AC-powered submerged arc-resistance furnace (not shown) with electric energy are connected to each other in FIG. 7 to a system (not marked) for the supply of a three-phase AC-powered electric arc furnace or a three-phase AC-powered submerged arc-resistance furnace (not marked) with electric energy such that each one-phase system (not marked) supplies one electrode 120 of the three-phase AC-powered electric arc furnace or the three-phase AC-powered submerged arc-resistance furnace (not marked).

For this purpose, all furnace power supply apparatuses 100 are connected to a three-phase power network 110.

Furthermore, all furnace power supply apparatuses 100 are connected to a combined electronic coordination and regulation unit 300.

The three electrodes 120 can be connected to each other in a star connection or a delta connection.

### LIST OF REFERENCE NUMERALS

100 Furnace power supply apparatus
110 Three-phase power network
120 Electrode
122 Cathode
124 Anode
200 Transformer/phase-shift transformer
210 Rectifier circuit
220 Smoothing circuit
230 Electronic control unit
240 Inverter circuit
250 Chopper circuit
260 Three-phase disconnector or circuit breaker
270 One-phase disconnector
300 Electronic coordination and regulation unit
310 Electrode regulator

1. A furnace power supply apparatus (100) for supply of an electric arc furnace or a submerged arc-resistance furnace with electric energy comprising
a three-phase transformer (200) with a primary circuit per phase and a secondary circuit per phase, wherein the three-phase transformer (200) is a phase-shifting transformer (200);
a rectifier circuit (210); and
a smoothing circuit (220) connected to the rectifier circuit (210),
wherein the furnace power supply apparatus (100) is connectable to a three-phase power network (110), and
wherein the furnace power supply apparatus (100) is connectable to at least one electrode (120) of the electric arc furnace or the submerged arc-resistance furnace.

2. The furnace power supply apparatus (100) according to claim 1, wherein the primary circuit of the transformer (200) is connectable to the three-phase power network (110) and the secondary circuit of the transformer (200) is directly connected to the rectifier circuit (210).

3. The furnace power supply apparatus (100) according to claim 1, wherein the furnace power supply apparatus (100) comprises an electronic control unit (230), which is connectable to an electronic coordination and regulation unit (300), whereby the electronic control unit (230) is operatively connected to the rectifier circuit (210) and adapted to regulate an active power flow of the furnace power supply apparatus (100).

4. The furnace power supply apparatus (100) according to claim 1, characterised in that the furnace power supply apparatus (100) comprises a chopper circuit (250) connected to the smoothing circuit (220).

5. The furnace power supply apparatus (100) according to claim 1, characterised in that the furnace power supply apparatus (100) comprises an inverter circuit (240) connected to the smoothing circuit (220).

6. The furnace power supply apparatus (100) according to claim 1, characterised in that the rectifier circuit (210) and/or the chopper circuit (250) and/or the inverter circuit (240) comprises at least one semiconductor element comprising silicon carbide.

7. The furnace power supply apparatus (100) according to claim 1, characterised in that the furnace power supply apparatus (100) comprises an electronic control unit (230), which is connectable to an electronic coordination and regulation unit (300), whereby the electronic control unit is adapted to control one or more of a current loop, a voltage loop, impedance loop, active power loop, and/or active power with a hysteresis loop of the furnace power supply apparatus (100).

8. A system for supply of two electrodes (120) of an electric arc furnace or a submerged arc-resistance furnace with electric energy comprising:
a plurality of furnace power supply apparatuses (100) connected in parallel,
wherein the system is connectable to a three-phase power network (110), and
wherein the system is connectable to one of the electrodes (120) of the electric arc furnace or the submerged arc-resistance furnace.

9. (canceled)

10. The system according to claim 8,
wherein a first of the plurality of furnace power supply apparatuses (100) is connectable to a first electrode (120), and
wherein at least one of the plurality of furnace power supply apparatuses (100) is connectable to a second electrode (120).

11. The system according to claim 8, characterised in that the system comprises an electrode regulator (310) per electrode (120).

12. The system according to claim 8, characterised in that the system comprises an electronic coordination and regulation unit which is operatively connected to an electronic control unit and/or an electrode regulator (310).

13. (canceled)

14. A method for operating an electric arc furnace or a submerged arc-resistance furnace, characterised in that a ratio of active power flow and reactive power flow is controlled and/or regulated by influencing a control quantity of a rectifier circuit (210), wherein the reactive power flow is minimized by influencing a control quantity of the rectifier circuit (210).
